(19) United States
(12) Patent Application Publication
(10) Pub. No.: US 2006/0215710 A1
(43) Pub. Date: Sep. 28, 2006

(54) Frame communication method and device

(75) Inventors: Wataru Odashima, Yokohama (JP); Katsuya Tsushita, Yokohama (JP); Susumu Suwa, Yokohama (JP); Yutaka Kosuge, Yokohama (JP); Takayuki Kato, Yokohama (JP); Takanobu Uegaki, Yokohama (JP); Kenichi Kamada, Yokohama (JP)

Correspondence Address: BINGHAM MCCUTCHEN LLP, 3000 K STREET, NW, BOX IP, WASHINGTON, DC, 20007, US

(73) Assignee: FUJITSU LIMITED

(21) Appl. No.: 11/190,141

(22) Filed: Jul. 27, 2005

(30) Foreign Application Priority Data
Mar. 25, 2005 (JP) 2005-088706

(51) Int. Cl. H04J 3/04

(52) U.S. Cl. 370/535

(57) ABSTRACT

In a frame communication method and device which can accurately reproduce received frames without being influenced by fluctuations of a frame interval caused by inter-channel multiplexing on a transmitting side, a frame interval is detected from transmission frames; information of the frame interval is added to the transmission frames; the transmission frames are multiplexed and transmitted. Also, the information of the frame interval is extracted from received frames demultiplexed; and the received frames are spaced by the frame interval to be transferred. When the frame interval exceeds a maximum frame interval determined by a bit number of the information of the frame interval, only information of the maximum frame interval is transmitted and information of subsequent remaining frame intervals is added to the transmission frames to be transmitted. Information of the maximum frame interval determined by a bit number of the information of the frame interval and information of subsequent remaining frame intervals are extracted from the received frames, and the received frames are spaced by the frame interval adding the information of the remaining frame intervals to the information of the maximum frame interval.

### BACKGROUND OF THE INVENTION

1. Field of the Invention

The present invention relates to a frame communication method and device, and in particular to a method and device for communicating data of a frame format in a SONET/SDH or the like.

2. Description of the Related Art

FIG. 13 schematically shows a prior art frame communication device, having a transmitting side composed of a subscriber device (terminal device) 1 and a transmitting side communication device 2, and a receiving side composed of a receiving side communication device 3, a subscriber device 4 and a buffer 5.

Encapsulation processing is performed to relatively low-speed transmission frames SF (see FIG. 14A) per channel from the subscriber device 1 by encapsulating portions 11_1-11_n (hereinafter, occasionally represented by a reference numeral “11”) respectively. Then, a plurality of frames are multiplexed, which is further multiplexed for all of the lines of “n” channels by a multiplexer 12, so that multiplexed data MF (see FIG. 14B) are transmitted to the receiving side through a high-speed line.

On the receiving side, the high-speed multiplexed frame MF from the transmitting side is received by a demultiplexer 13 in the communication device 3 to be demultiplexed into frames of “n” channels. The capsules are removed from “n” channels of frames in decapsulating portions 14_1-14_n (hereinafter, occasionally represented by a reference numeral “14”) to be transferred to the subscriber device 4 in the form of low-speed transferring frames TF (see FIG. 14C). The buffer 5 and the subscriber device 4 are mutually connected.

Also, in a digital multiplexing transmission device which multiplexes a plurality of digital streams into transmission slots of a multiplexed frame to be transmitted per digital stream, a time when inputted digital data reach a data amount transmitted by a single transmission slot is detected, slot assigning information of the digital stream for which the time is detected is generated, the digital streams are multiplexed according to the generated slot assigning information, the slot assigning information is added to the multiplexed frame to be transmitted to the receiving side (see e.g. patent document 1).

Also, there is a multiple ring-shaped optical network for a burst communication, in which frames transmitted on a multiplexed ring-shaped optical network include burst data composed of data of numerous packets and header data indicating a destination of the burst data (see e.g. patent document 2).

[Patent document 1] Japanese Patent No. 34347695

[Patent document 2] Japanese Patent Application Laid-open No. 2004-140831

Since the prior art example as shown in FIG. 13 performs buffering for multiplexing at the multiplexer 12 of the transmitting side communication device 2, frames are reproduced on the receiving side at a burst, so that there is a problem that frame intervals (transmission rate) at the time of the transmission can not be reproduced.

Thus, the frames reproduced are to burst and fluctuate, so that deviation occurs in a transfer rate from the receiving side communication device 3 to the subscriber device 4. In order to absorb such deviation, it has been required to provide the buffer 5 in the individual subscriber device 4.

Also, in order to prevent such a buffer from overflowing, a flow control is required, resulting in a problem that together with the flow control, a circuit becomes complicated and its scale becomes extremely large.

### SUMMARY OF THE INVENTION

It is accordingly an object of the present invention to provide a frame communication method and device which can accurately reproduce a received frame without being influenced by fluctuations of frame intervals associated with inter-channel multiplexing on a transmitting side.

In order to achieve the above-mentioned object, a frame communication method and device according to the present invention in one preferred mode comprise: a first step or means of detecting a frame interval from transmission frames; and a second step or means of adding information of the frame interval to the transmission frames and of multiplexing the transmission frames to be transmitted.

Also, a frame communication method and device according to the present invention in one preferred mode comprise: a third step or means of extracting information of a frame interval from received frames demultiplexed; and a fourth step or means of spacing the received frames by the frame interval to be transferred.

FIG. 1 shows a principle diagram of the present invention in one preferred mode. As shown in the principle diagram, a transmitting side communication device 2 and a receiving side communication device 3 realizing the frame communication method of the present invention are the same as those in the prior art example shown in FIG. 13, where the subscriber device 4 does not require a buffer absorbing deviation of a data rate different from the prior art example.

Namely, on the transmitting side of the frame communication method according to the present invention, as shown in operation time charts of FIGS. 2A-2C, transmission frames SF from a subscriber device 1 corresponding to e.g. a channel CH1 have frame intervals t1, t2, t3, . . . , as shown in FIG. 2A, and are forwarded to a corresponding encapsulating portion 11_1 of the channel CH1. In the encapsulating portion 11_1, the above-mentioned frame intervals t1, t2, and t3 are detected, and the information of the frame intervals, as shown by (2) of FIG. 1, is added to the transmission frames SF as frame interval information FII. Then, the frames are encapsulated with a frame separation FS or the like to be transmitted to a multiplexer 12.

In the multiplexer 12, as shown by (2) of FIG. 1 and in FIG. 2B, three sequential transmission frames are multiplexed in the channel CH1. Also, inter-channel multiplexing is performed during a multiplexing period FP to transmission frames (not shown) from encapsulating portions 11_2-11_n of the other channels to be transmitted to the receiving side as multiplexed frames MF.

On the receiving side, a demultiplexer 13 in the communication device 3 demultiplexes the multiplexed frames MF shown by (2) of FIG. 1 and in FIG. 2B per channel to be respectively transmitted to decapsulating portions 14_1-14_n. In the decapsulating portions 14_1-14_n, frame intervals such as t1, t2, and t3 included in the frame interval information FII added to the transmission frames SF transmitted from the transmitting side are extracted. Based on the extracted frame intervals t1, t2 and t3, the intervals of the transferring frames are reproduced. The same is performed to the other decapsulating portions 14_2-14_n. As shown by (3) of FIG. 1 and in FIG. 2C, the transferring frames TF are outputted from the decapsulating portions 14 and transmitted to the respective subscriber devices 4.

Accordingly, even if fluctuations due to buffering of the frames occur in the multiplexer 12 on the transmitting side, the frames reproduced on the receiving side can reproduce the frame intervals on the transmitting side unchanged since the fluctuations are relative ones. Thus, the buffer 5 as shown in FIG. 13 becomes unnecessary for the subscriber device 4. Therefore, a flow control function is not required, the circuit arrangement is simplified and its scale is downsized.

When the frame interval exceeds a maximum frame interval determined by a bit number of the information of the frame interval, the above-mentioned second step or means may include a step or means of transmitting only information of the maximum frame interval, and a step or means of adding information of subsequent remaining frame intervals to the transmission frames to be transmitted.

Also, the above-mentioned third step or means may include a step or means of extracting information of a maximum frame interval determined by a bit number of the information of the frame interval and information of subsequent remaining frame intervals from the received frames, and the fourth step or means may include a step or means of spacing the received frames by the frame interval adding the information of the remaining frame intervals to the information of the maximum frame interval.

Namely, this is for countering a case where the frame interval exceeds a maximum frame interval determined by a bit number of the information of the frame interval. Within this interval, the transmission frame can not appear in such a case, so that only the frame interval information of the maximum value is transmitted. As for the information of subsequent remaining frame intervals, the transmission frame can appear, so that the information is added to the transmission frame.

On the receiving side, the information of the maximum frame interval and the information of the subsequent remaining frame intervals are extracted from the received frames, wherein the received frames are spaced by the frame interval to which both of the frame information are added, thereby enabling accurate frame intervals to be kept for the frame transmission of a long period.

It is to be noted that the above-mentioned second step or means may include a step or means of multiplexing the information of the frame interval per channel.

Also, the above-mentioned second step or means may include a step or means of multiplexing the information of the frame interval over a plurality of channels.

Furthermore, the above-mentioned second step or means may further include a step or means of assigning the information of the frame interval to a free bit of a predetermined frame format.

According to the present invention, it becomes possible to keep the frame interval on the receiving side the same as that of the transmitting side. Also, the buffer becomes unnecessary for the subscriber device, and a flow control becomes unnecessary. As a result, it becomes possible to simplify a circuit and to reduce a circuit scale, which can eventually realize a cost reduction of the subscriber device.

### BRIEF DESCRIPTION OF THE DRAWINGS

The above and other objects and advantages of the invention will be apparent upon consideration of the following detailed description, taken in conjunction with the accompanying drawings, in which the reference numerals refer to like parts throughout and in which:

FIG. 1 is a block diagram illustrating a principle of a frame communication method and device according to the present invention;

FIGS. 2A-2C are operation time chart diagrams corresponding to the principle diagram of the present invention shown in FIG. 1;

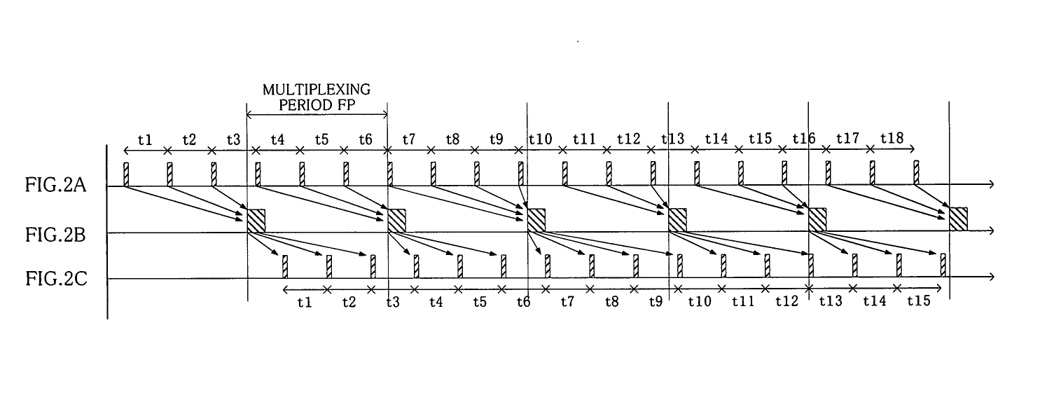

FIG. 3 is a block diagram showing an embodiment of an arrangement of a transmitting side communication device used for the present invention;

FIGS. 4A-4F are time chart diagrams showing an operation embodiment (1) of the transmitting side communication device shown in FIG. 3;

FIG. 5 is a block diagram showing an embodiment of an arrangement of a receiving side communication device used for the present invention;

FIGS. 6A-6E are time chart diagrams showing an operation embodiment (1) of the receiving side communication device shown in FIG. 5;

FIGS. 7A-7F are time chart diagrams showing an operation embodiment (2) of a transmitting side communication device in the present invention;

FIGS. 8A-8E are time chart diagrams showing an operation embodiment (2) of a receiving side communication device in the present invention;

FIGS. 9A-9C are time chart diagrams showing an operation embodiment (3) of a frame communication method and device according to the present invention;

FIGS. 10A-10E are time chart diagrams showing an operation embodiment (4) of a frame communication method and device according to the present invention;

FIGS. 11A-11C are time chart diagrams showing an operation embodiment (5) of a frame communication method and device according to the present invention;

FIG. 12 is a format diagram of a frame used in the present invention;

FIG. 13 is a block diagram showing a schematic arrangement of a prior art example; and

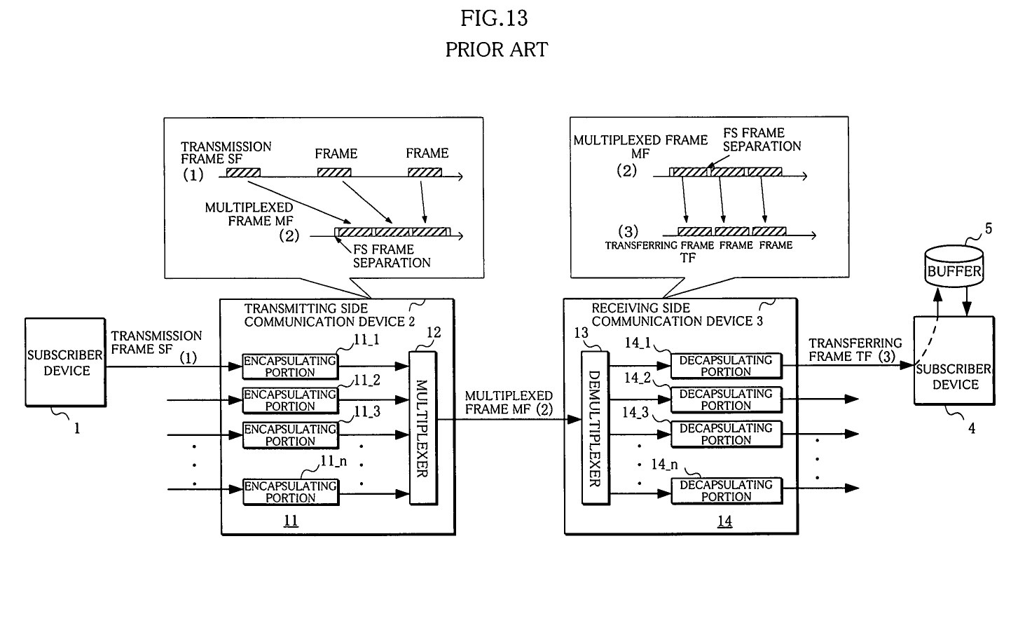

FIGS. 14A-14C are time chart diagrams showing an operation example of the prior art example shown in FIG. 13.

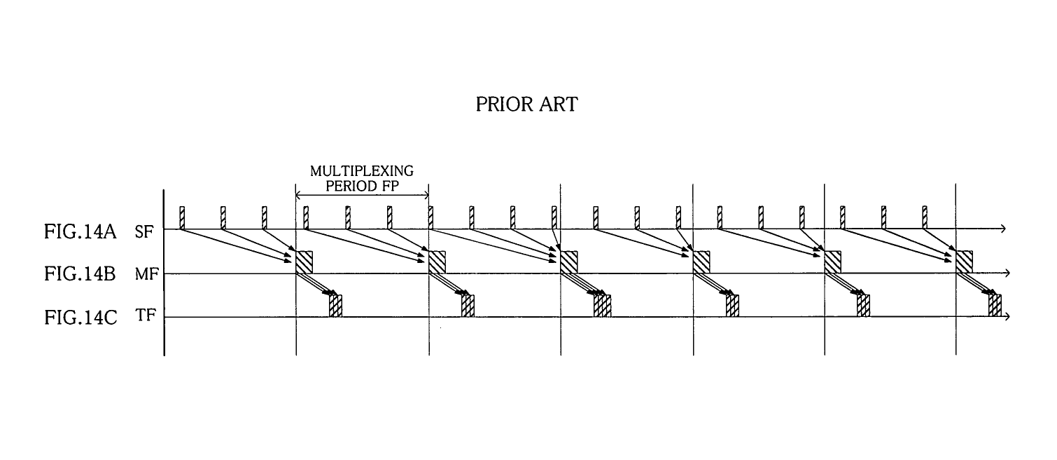

### DESCRIPTION OF THE EMBODIMENTS

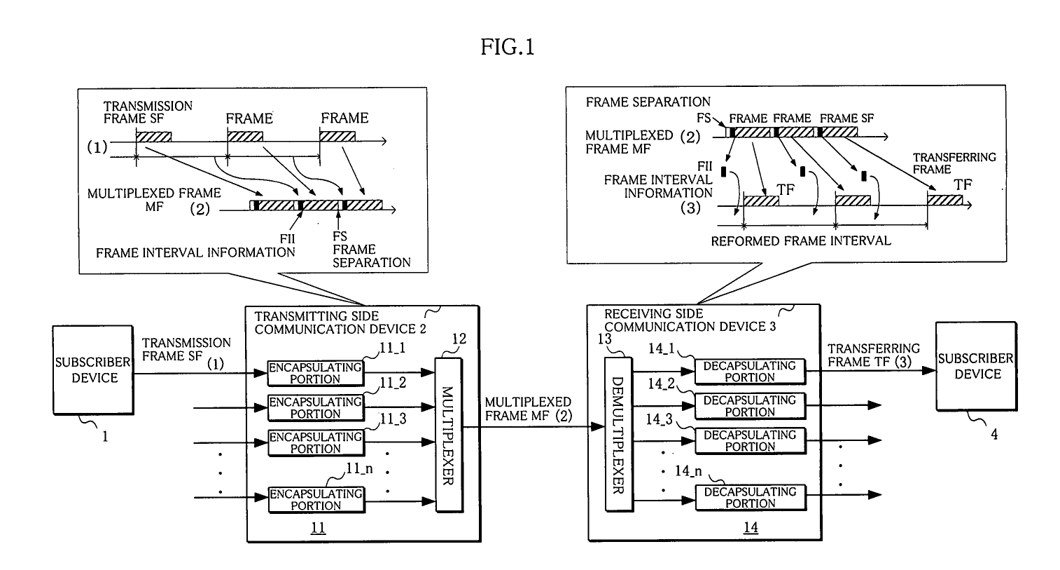

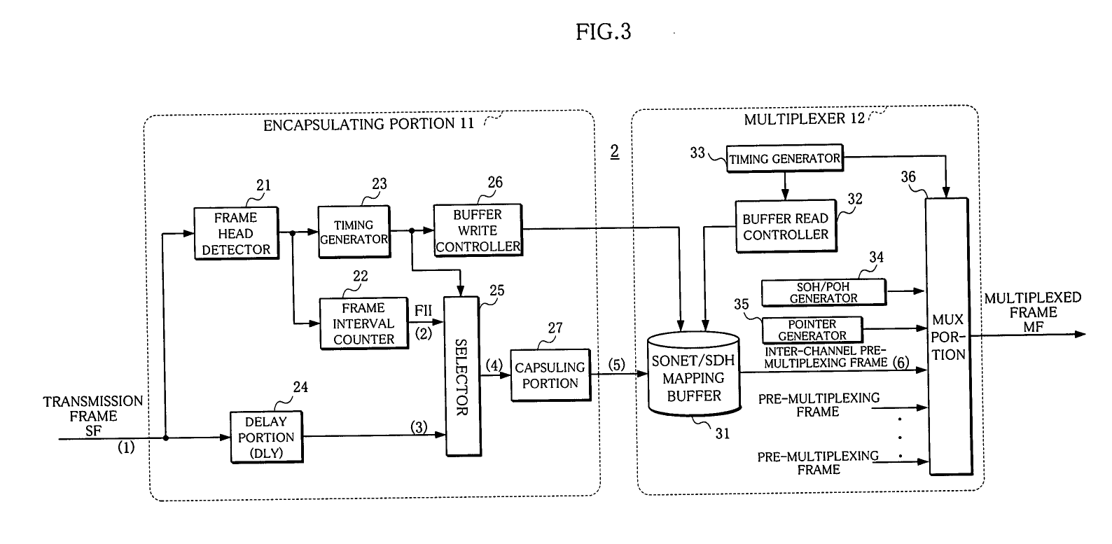

FIG. 3 shows an embodiment of an arrangement of the transmitting side communication device 2 used for a frame communication method and device according to the present invention whose principle is shown in FIG. 1.

In the embodiment of the arrangement shown in FIG. 3, the encapsulating portion 11 shown in FIG. 1 is composed of a frame head detector 21 for detecting a frame head by inputting the transmission frame SF (1), a frame interval counter 22 connected to the frame head detector 21, for detecting an interval between frames (interval between a frame head and a subsequent frame head) and for outputting the information FII (2), a timing generator 23 for generating a timing signal based on a detection timing of the frame head detector 21, a delay portion 24 for outputting the frame (3) that is the transmission frame SF to which a fixed processing delay time DLY is provided, a selector 25 for selecting an output signal (4) of the frame interval counter 22 or the delay portion 24 based on the timing signal from the timing generator 23, a buffer write controller 26 for controlling a write to a mapping buffer in the multiplexer 12, which will be described later, based on the timing signal from the timing generator 23, and a capsuling portion 27 for capsuling an output signal (4) from the selector 25 to be transmitted to the multiplexer 12.

Also, the multiplexer 12 is composed of a SONET/SDH mapping buffer 31 for writing the encapsulated frame from the capsuling portion 27 in the encapsulating portion 11 based on the control signal from the buffer write controller 20, a buffer read controller 32 for reading frames from the mapping buffer 31, a timing generator 33 for providing a timing signal to the buffer read controller 32, an SOH/POH generator 34 for generating an SOH (Section Over Head) and a POH (Path Over Head) as header information, a pointer generator 35 for generating a pointer for pointing a position of payload data, and a MUX portion 36 for multiplexing output signals from the SOH/POH generator 34 and the pointer generator 35 and a frame (6) per channel from the mapping buffer 31 based on the timing signal from the timing generator 33 and outputting the multiplexed frame MF to the receiving side.

Operation Embodiment (1) (Transmitting Side):

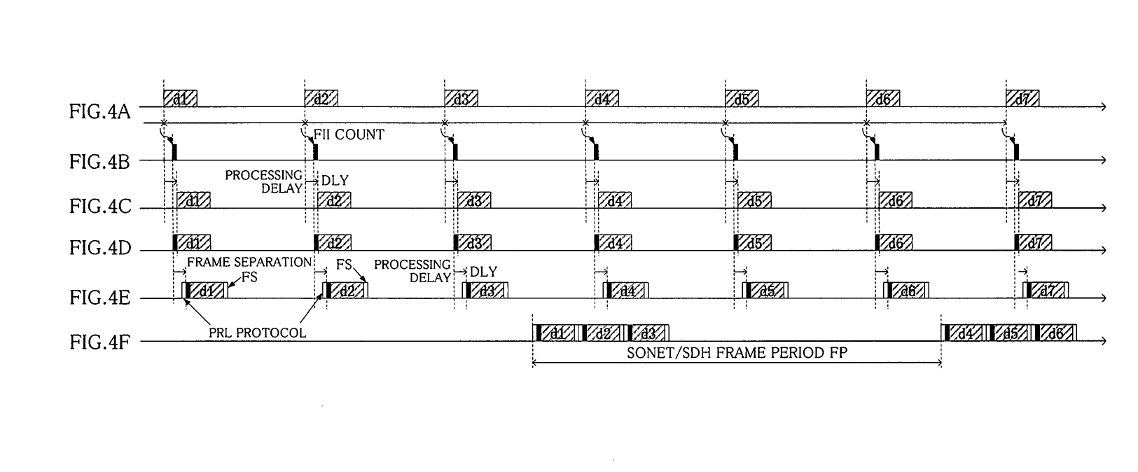

The operation of the transmitting side communication device 2 will now be described referring to an operation embodiment (1) shown in FIGS. 4A-4F. It is to be noted that signals (1)-(6) in FIG. 3 correspond to those shown in FIGS. 4A-4F, respectively.

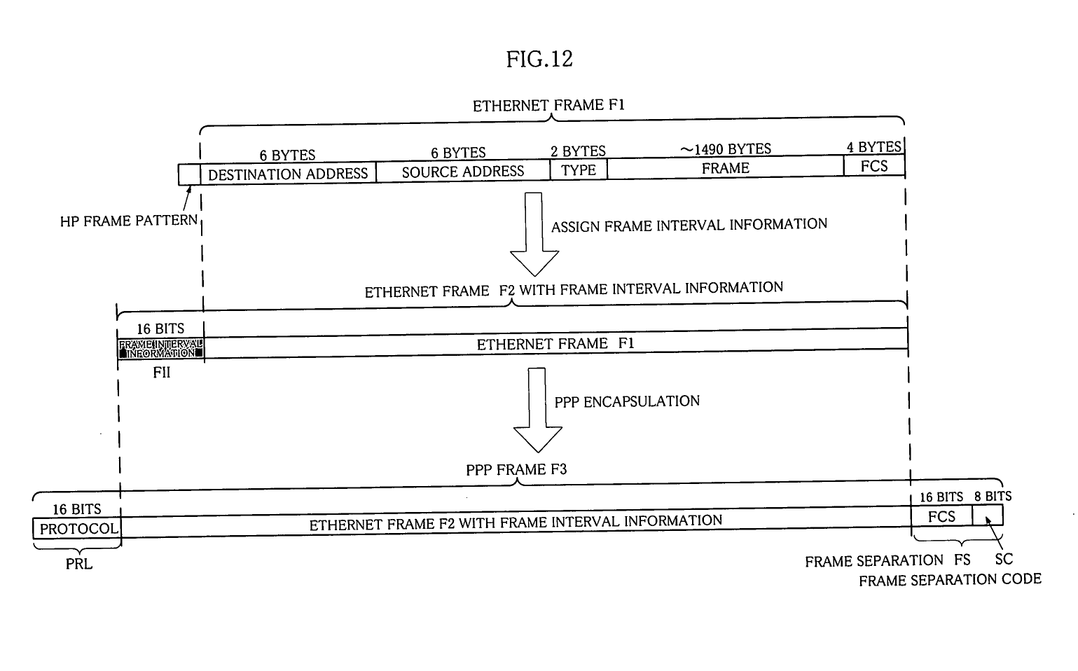

Firstly, when the transmission frame SF shown in FIG. 3 is inputted to the encapsulating portion 11, the frame head detector 21 detects a head of a frame d1 composing the transmission frame SF. As shown in a frame format of FIG. 12, this is performed by detecting a frame pattern HP of an Ethernet (registered trademark) frame F1. At the time of this frame head detection, counting the frame interval counter 22 is started. The counter 22 stops counting when the frame head detector 21 receives a subsequent transmission frame d2 and the head of the frame is detected. The count is provided to the selector 25 as the frame interval information FII (2).

On the other hand, the transmission frame SF (1) is provided to the selector 25 as the frame (3) delayed by the fixed processing delay DLY through the delay portion 24.

Accordingly, the selector 25 firstly selects the frame interval information FII that is the count based on the timing signal from the timing generator 23, and selects corresponding transmission frames d1, d2, d3, . . . at the subsequent timing signal. Therefore, the selected output frame (4) has the frame interval information FII and the transmission frames d1, d2, d3, . . . multiplexed within the same channel. This corresponds to a frame F2=frame interval information FII+Ethernet (registered trademark) frame F1 in the frame format in FIG. 12.

The capsuling portion 27 having received the output frame (4) from the selector 25 adds a protocol PRL (16 bits) and a frame separation FS (combination of FCS (Frame Check Sequence: 16 bits) and a frame separation code SC (8 bits)) to the frame F2, and performs tunneling PPP encapsulation to generate a frame F3 (frame (5)).

When the encapsulated frame (5) is transmitted to the mapping buffer 31 in the multiplexer 12, the mapping buffer 31 writes the frame (5) under the control of the buffer write controller 26 receiving the timing signal from the timing generator 23. In the multiplexer 12, the timing generator 33 generates the timing signal, and the buffer read controller 32 reads the written frame from the mapping buffer 31 based on the timing signal.

As a result, a frame (6) read from the mapping buffer 31 is a frame (multiplexed frame) obtained by sequentially reading the encapsulated transmission frames d1, d2, and d3 shown in FIG. 4E, as shown in FIG. 4F. Transmission frames d4, d5, d6 are read, as shown, from the buffer 31 newly and sequentially after the SONET/SDH frame period FP has elapsed. It is to be noted that the transmission frames (not shown) in other channels are inserted between the transmission frames d1, d2 and d3 encapsulated and the transmission frames d4, d5 and d6 encapsulated in the subsequent frame period.

By providing the header from the SOH/POH generator 34 in the frame period FP and the pointer from the pointer generator 35 to the MUX portion 36, the multiplexed frame MF is generated and transmitted to the receiving side.

Thus, the information of the frame interval detected from the transmission frames is added to the transmission frames to be multiplexed, and then the multiplexed frame is transmitted to the receiving side.

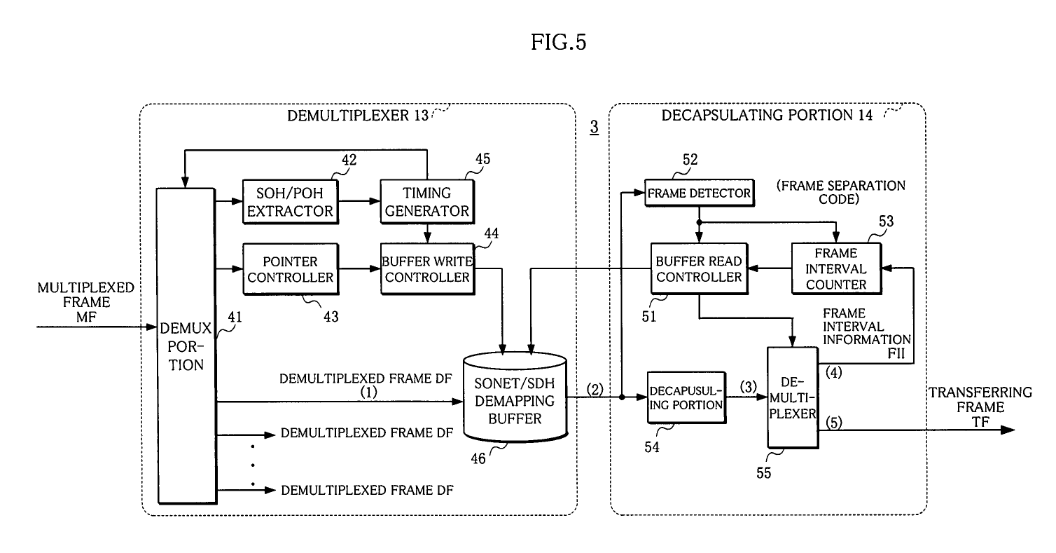

FIG. 5 shows an arrangement embodiment of the receiving side communication device 3 whose principle is shown in FIG. 1.

In this embodiment, the demultiplexer 13 is composed of a DEMUX portion 41 for inputting the multiplexed frame MF to be demultiplexed into a frame DF (1), an SOH/POH extractor 42 for extracting the SOH and POH by header information from the DEMUX portion 41, a pointer controller 43 for extracting a pointer from the header information similarly, a buffer write controller 44 for performing a buffer write control based on the pointer controller 43, a timing generator 45 for providing a timing signal to the buffer write controller 44 and the DEMUX portion 41, and a demapping buffer 46 for writing the demultiplexed frame DF (1) from the DEMUX portion 41 by the buffer write controller 44.

Also, decapsulating portion 14 is composed of a buffer read controller 51 for performing a read control of the frame from the demapping buffer 46 in the demultiplexer 13, a frame detector 52 for performing a frame detection according to the frame separation code (see FIG. 12) from the frame (2) read from the demapping buffer 46, a frame interval counter 53 for starting an operation together with the buffer read controller 51 at the timing at which the frame is detected by the frame detector 52, a decapsuling portion 54 for releasing a capsule in the frame (2) read from the demapping buffer 46, and a demultiplexer 55 for demultiplexing the frame (3) decapsulated by the decapsuling portion 54 into the frame interval information FII and the transferring frame TF to the subscriber device 4 (see FIG. 1) based on the control signal by the buffer read controller 51.

Operation Embodiment (1) (Receiving Side):

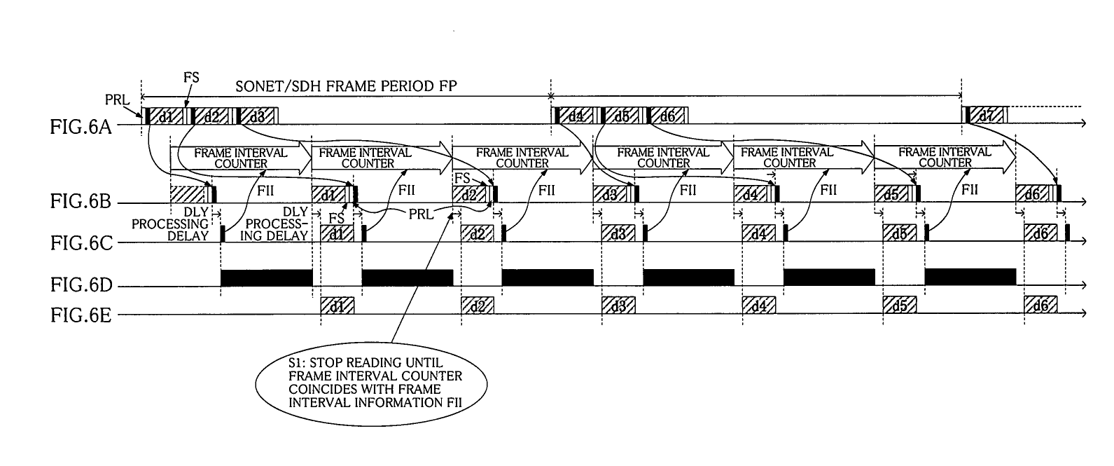

Hereinafter, an operation embodiment (1) of the receiving side communication device 3 will be described referring to FIGS. 6A-6E.

Firstly, the DEMUX portion 41 in the demultiplexer 13 having received the multiplexed frame MF outputted from the MUX portion 36 in the multiplexer 12 shown in FIG. 3 demultiplexes the frame DF (1) per channel as shown in FIG. 6A. This corresponds to a frame shown in FIG. 4F.

The frame DF (1) demultiplexed from the DEMUX portion 41 is written in the demapping buffer 46. At this time, by the timing signal generated by the timing generator 45 based on the header information extracted by the SOH/POH extractor 42 and the pointer of the header information extracted by the pointer controller 43, the buffer write controller 44 controls writing.

The frame (2) is read from the demapping buffer 46 based on the control of the buffer read controller 51. This is firstly performed at the timing initially set in the frame detector 52.

The decapsuling portion 54 having received the frame (2), in case of e.g. the frame d1 shown in FIG. 6C, outputs only the frame d1 from which the protocol PRL and the frame separation FS are removed and the frame interval information FII. When receiving the frame (3), the demultiplexer 55 demultiplexes the frame (3) into the frame interval information FII (4) and the transferring frame TF (d1, d2, . . . ) (5).

The frame interval information FII (4) demultiplexed by the demultiplexer 55 is loaded to the frame interval counter 53, and a carry-over value of the frame interval counter 53 is set. Accordingly, the frame interval counter 53 starts the operation when the frame detector 52 detects the frame by the frame separation code FS, and makes the buffer read controller 51 an enable state, by being loaded with the frame interval information FII, until the value of the frame interval information FII=count. Therefore, the buffer read controller 51 keeps on reading the frame (2) from the demapping buffer 46. At the time of the information FII=count, the read of the frame (2) is stopped (at step S1). Thus, as shown in FIG. 6E, the transferring frame TF (5) is transmitted to the subscriber device 4 from the decapsulating portion 14 at the same frame intervals as the transmission frames d1, d2, d3, . . . shown in FIG. 4A.

Thus, the frame intervals are extracted from the received frames, and the received frames are transferred after being spaced by the frame intervals.

Various operation embodiments in the following can be performed by using the transmitting side communication device 2 shown in FIG. 3 and the receiving side communication device 3 shown in FIG. 5.

Operation Embodiment (2) (Transmitting Side):

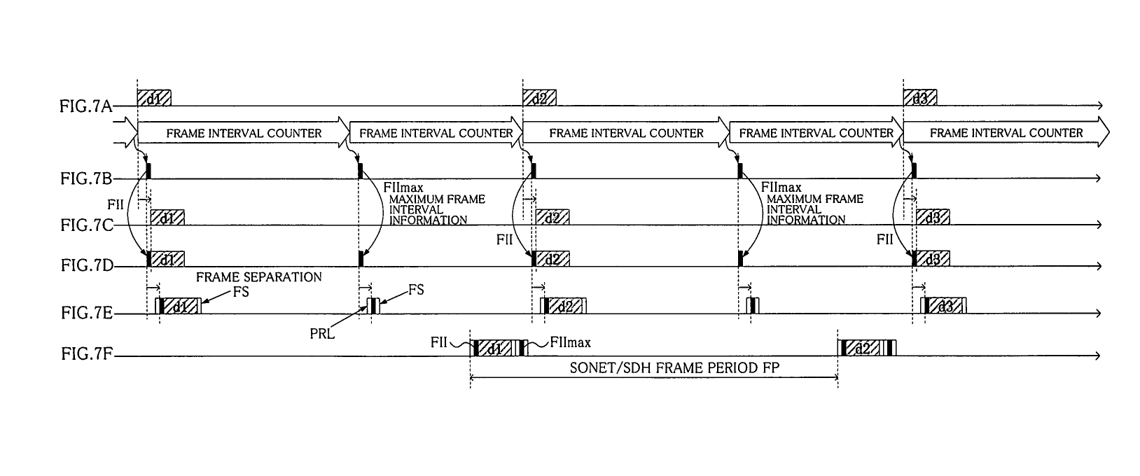

FIGS. 7A-7F show an operation embodiment (2) of the transmitting side communication device 2. In this operation embodiment (2), as shown by the transmission frames d1 and d2 of FIG. 7A, the transmission frames SF have a frame interval whose period is longer than that of the frame interval information provided by the frame interval counter 22.

Therefore, the frame interval counter 22 starts its operation in the encapsulating portion 11 shown in FIG. 3 when the frame head detector 21 detects the head of e.g. the frame d1. However, when the frame interval exceeds the maximum value FIImax (carry-over value) of the count, the selector 25 selects an output (2) of the frame interval counter 22. Then, the selector 25 can not select a frame by the subsequent timing signal since the frame d2 has not arrived yet from the delay portion 24. Accordingly, only the maximum frame interval FIImax is transmitted to the capsuling portion 27.

After the carry-over, the frame interval counter 22 restarts counting from 0. Since counting is stopped when the head of the subsequent frame d2 is detected, the output (4) of the selector 25 at the time of the count stop assumes the frame interval FII+frame d2. Thus, the output (4) assumes “FII+d1”, “FIImax”, “FII+d2”,

Thus, the frame (5) outputted from the capsuling portion 27 assumes, in the example of FIG. 7E, “frame interval FII+frame d1” encapsulated, only “frame interval information of the maximum value FIImax” encapsulated, and “frame interval FII+frame d2” encapsulated,

Accordingly, a frame (6) outputted from the mapping buffer 31, as shown in FIG. 7F, assumes a series of “frame interval FII+transmission frame d1” encapsulated, and “frame interval information of the maximum value FIImax” encapsulated. Namely, the frames are multiplexed within the same channel to be transmitted to the MUX portion 36.

Other operations are the same as those described in FIGS. 3, 4A, 4B, 4C, 4D, 4E and 4F.

Operation Embodiment (2) (Receiving Side):

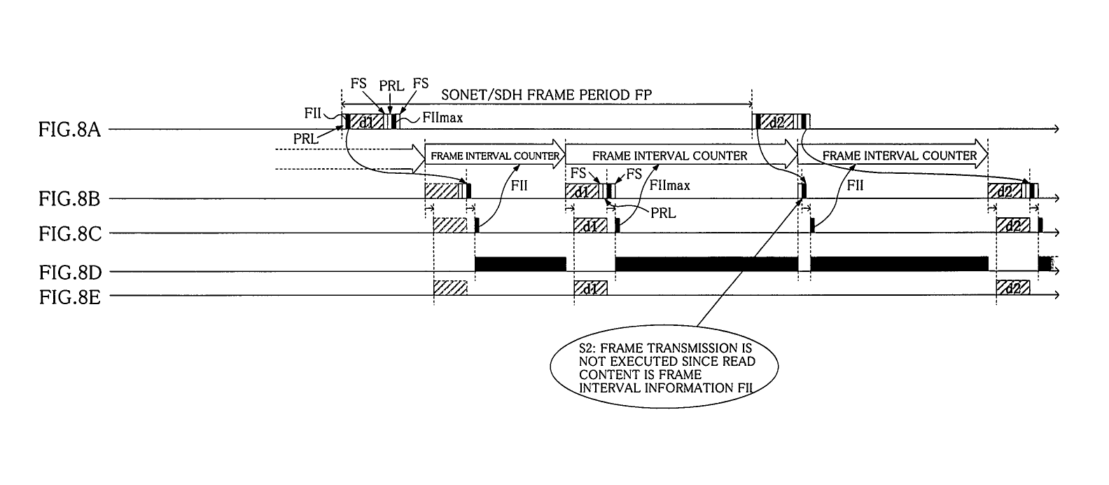

FIGS. 8A-8E show an operation embodiment (2) of the receiving side communication device corresponding to FIGS. 7A-7F. Namely, a frame shown in FIG. 7F, in the same way as the above-mentioned operation embodiment (1), corresponds to the frame DF (1) of FIG. 8A demultiplexed from the DEMUX portion 41 in the demultiplexer 13 of the receiving side communication device 3.

Such a frame DF (1) is written in the demapping buffer 46 in the same way as the above, and is read by the buffer read controller 51 in the decapsulating portion 14. At the time when the frame detector 52 detects the frame by the frame separation code, the buffer read controller 51 starts reading. Therefore, the frame is read, as shown in FIG. 8B, in the order of e.g. the transmission frame d1→frame separation FS→protocol PRL frame interval information FII→frame separation FS to be transmitted to the decapsuling portion 54.

The decapsuling portion 54 provides a frame from which the frame separation FS, the frame protocol PRL and the frame separation FS are removed as shown in FIG. 8C to the demultiplexer 55.

The demultiplexer 55 demultiplexes the frame into the frame interval information FII and the frame d1, and loads the frame interval information FII to the frame interval counter 53. Accordingly, the frame interval counter 53 counts from the detection of the head of the present frame d1 to the frame interval information FII presently loaded, and the frames are read from the buffer 46.

Since the content read from the buffer 46 is not the frame but the frame interval information FII, as shown in FIG. 8B, when the counter 53 carries over, the frame transmission is not performed from the demapping buffer 46 by the read control portion 51 (at step S2). Hereafter, when the counter 53 reaches the information FII of the remaining frame interval, the subsequent frame d2 is read from the buffer 46. Accordingly, next to the frame d1, the frame d2 is to be outputted as the transferring frame TF at the frame interval FIImax+FII.

Thus, the frames d1 and d2 having a long period, which are the same as those on the transmitting side, are outputted as transferring frames TF, as shown in FIG. 8E, from the demultiplexer 55.

Operation Embodiment (3) (Transmitting/Receiving Side):

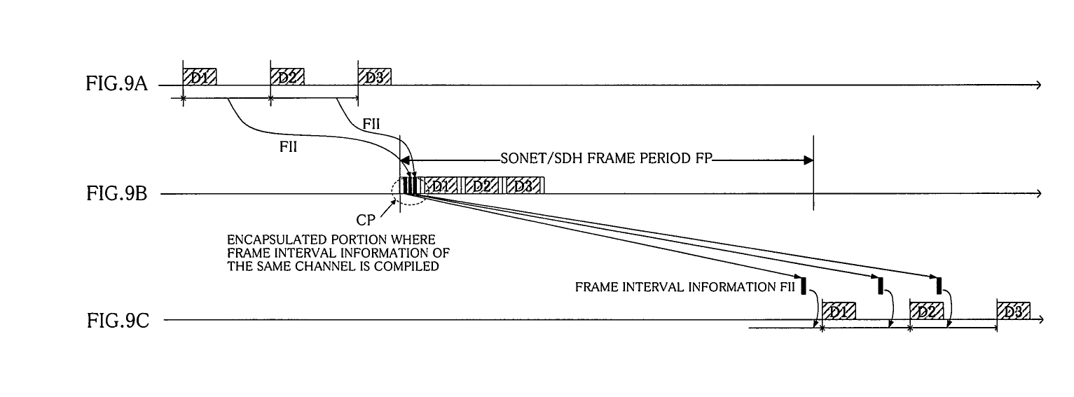

FIGS. 9A-9C show an operation embodiment (3). In this embodiment, as shown in FIG. 9A, each frame interval information FII is detected for the transmission frame SF. Then, the frame interval information FII over the frame period FP of the same channel is compiled as shown in FIG. 9B so as to be encapsulated. The encapsulated portion CP is inserted (multiplexed) into an inter-channel pre-multiplexing frame, and as shown in FIG. 9B, is encapsulated within a single frame period FP.

Accordingly, when the frame intervals are reproduced on the receiving side, they are respectively divided as shown in FIG. 9C, and the frame intervals are set in the same way as the above.

Operation Embodiment (4) (Transmitting/Receiving Side):

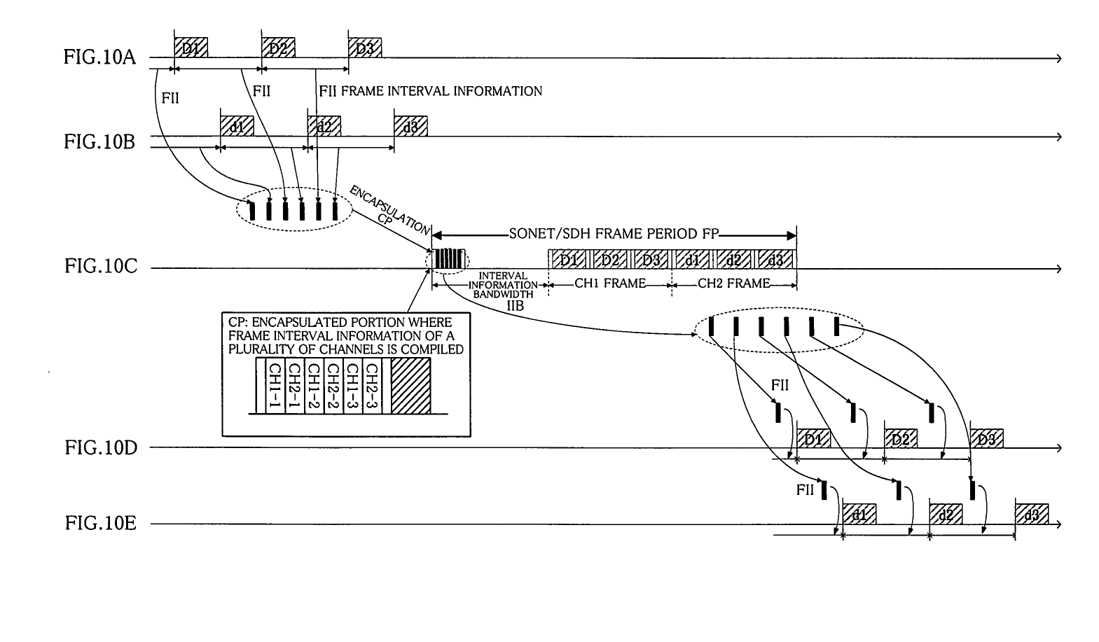

FIGS. 10A-10E show an operation embodiment (4) of the present invention. While the embodiment shown in FIGS. 9A-9C is to multiplex a frame interval information between the same channel, this embodiment enables the multiplexing between a plurality of channels.

Namely, in the presence of the frames of a channel CH1 in FIG. 10A and the frames of a channel CH2 in FIG. 10B, frame interval information FII of the channels CH1 and frame interval information FII of the CH2 are respectively compiled, as shown in FIG. 10C, to be inserted (multiplexed) into the inter-channel pre-multiplexing frame in the same way as the above-mentioned operation embodiment (3), and encapsulated, as shown, within a single frame period FP.

In this example, three frames D1, D2, and D3 of the channel CH1 and three frames d1, d2, and d3 of the channel CH2 are compiled into the encapsulated portion CP.

In a receiving side communication device having received such frames, as shown in FIGS. 10D and 10E, the frame interval information FII over a plurality of channels encapsulated is demultiplexed, the frame intervals of the channel CH1 are reproduced, and the frame intervals of the channel CH2 are reproduced as shown in FIG. 10E, thereby enabling frames D1, D2, D3, . . . d1, d2, d3, . . . of each channel to be reproduced as shown in FIGS. 10A and 10B.

Operation Embodiment (5) (Transmitting/Receiving Side):

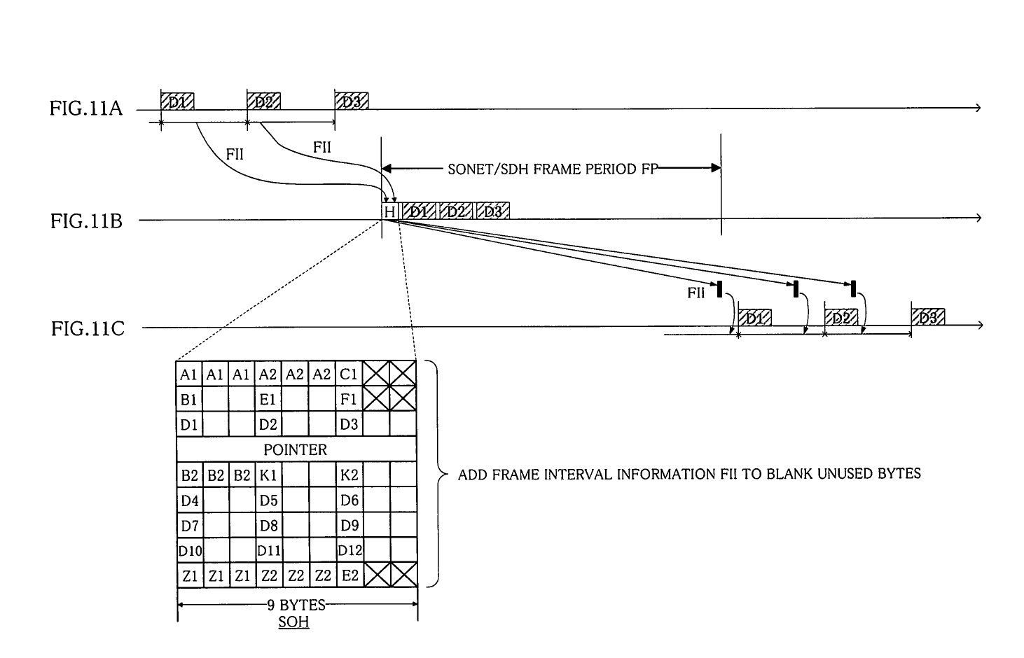

FIGS. 11A-11C show an operation embodiment (5) of the present invention. In this embodiment, the frame interval information FII of the transmission frames SF (D1, D2, and D3) shown in FIG. 11A is multiplexed by adding the information to an unused byte that is blank in e.g. the SOH of the SDH frame.

Accordingly, in the receiving side communication device having received such a multiplexed frame, the frame interval information FII stored in the unused byte in the SOH is taken out, so that the frames can be transferred with frame intervals of the frames D1, D2, and D3.

1. A frame communication method comprising:
a first step of detecting a frame interval from transmission frames; and
a second step of adding information of the frame interval to the transmission frames and of multiplexing the transmission frames to be transmitted.

2. A frame communication method comprising:
a third step of extracting information of a frame interval from received frames demultiplexed; and
a fourth step of spacing the received frames by the frame interval to be transferred.

3. The frame communication method as claimed in claim 1, wherein when the frame interval exceeds a maximum frame interval determined by a bit number of the information of the frame interval, the second step includes a step of transmitting only information of the maximum frame interval, and a step of adding information of subsequent remaining frame intervals to the transmission frames to be transmitted.

4. The frame communication method as claimed in claim 2, wherein the third step includes a step of extracting information of a maximum frame interval determined by a bit number of the information of the frame interval and information of subsequent remaining frame intervals from the received frames, and the fourth step includes a step of spacing the received frames by the frame interval adding the information of the remaining frame intervals to the information of the maximum frame interval.

5. The frame communication method as claimed in claim 1,
wherein the second step includes a step of compiling the information of the frame interval per channel and of adding the information of the frame interval compiled to the transmission frames to be multiplexed.

6. The frame communication method as claimed in claim 1, wherein the second step includes a step of compiling the information of the frame interval over a plurality of channels and of adding the information of the frame interval compiled to the transmission frames to be multiplexed.

7. The frame communication method as claimed in claim 1, wherein the second step further includes a step of assigning the information of the frame interval to a free bit of a predetermined frame format.

8. A frame communication device comprising:
first means detecting a frame interval from transmission frames; and
second means adding information of the frame interval to the transmission frames and multiplexing the transmission frames to be transmitted.

9. A frame communication device comprising:
third means extracting information of a frame interval from received frames demultiplexed; and
fourth means spacing the received frames by the frame interval to be transferred.

10. The frame communication device as claimed in claim 8, wherein when the frame interval exceeds a maximum frame interval determined by a bit number of the information of the frame interval, the second means include means transmitting only information of the maximum frame interval, and means adding information of subsequent remaining frame intervals to the transmission frames to be transmitted.

11. The frame communication device as claimed in claim 9, wherein the third means include means extracting information of a maximum frame interval determined by a bit number of the information of the frame interval and information of subsequent remaining frame intervals from the received frames, and the fourth means include means spacing the received frames by the frame interval adding the information of the remaining frame intervals to the information of the maximum frame interval.

12. The frame communication device as claimed in claim 8, wherein the second means include means compiling the information of the frame interval per channel and adding the information of the frame interval compiled to the transmission frames to be multiplexed.

13. The frame communication device as claimed in claim 8, wherein the second means include means compiling the information of the frame interval over a plurality of channels and adding the information of the frame interval compiled to the transmission frames to be multiplexed.

14. The frame communication device as claimed in claim 8, wherein the second means further include means assigning the information of the frame interval to a free bit of a predetermined frame format.
